(19) United States
(12) Patent Application Publication
(10) Pub. No.: US 2005/0108375 A1
(43) Pub. Date: May 19, 2005

(54) Method and graphical user interface for managing and configuring multiple clusters of virtualization switches

(76) Inventor: Michele Hallak-Stamler, Herzelia (IL)

Correspondence Address: KATTEN MUCHIN ZAVIS ROSENMAN, 575 MADISON AVENUE, NEW YORK, NY, 10022-2585, US

(21) Appl. No.: 10/712,955

(22) Filed: Nov. 13, 2003

(51) Int. Cl. G06F 15/173; G06F 15/167; G06F 15/177; G06F 12/00

(52) U.S. Cl. 709/223; 709/212; 709/213; 709/220; 711/170

(57) ABSTRACT

A method and a graphical user interface (GUI) for managing and configuring clusters of virtualizations switches of a storage area network (SAN) are disclosed. The method and GUI allow a user (e.g., a system administrator) to easily create virtual volumes through a virtual management unit (VMU) and configure virtual volumes through a GUI. In addition, a data manager (DM) facilitates communication with virtualization switches. Furthermore, the disclosed method enables the monitoring of virtualization switch status and further indicates failures by sending alerts to a user.

### BACKGROUND OF THE INVENTION

1. Field of Invention

The present invention relates generally to the field of storage area networks. More specifically, the present invention is related to the management and configuration of virtualization switches in a storage area network.

2. Discussion of Prior Art

Rapid growth of data intensive applications continues to fuel the demand for raw data storage capacity. As a result, there is an increasing need for storage space, storage services, and file servers to meet the needs of an increasing number of applications and users. To meet this growing demand, the concept of a storage area network (SAN) was introduced. A SAN is defined as a network whose primary purpose is to transfer data between computer systems and storage devices. In a SAN environment, switches and appliances generally interconnect storage devices and servers. This structure allows for any server in the SAN to communicate with any storage device also in the SAN and vice versa. This structure is advantageous in that it provides alternate paths for the transfer of data between a server and a storage device.

To increase the utilization of SANs, extend the scalability of associated storage devices, and increase the availability of data stored on a SAN; the concept of storage virtualization has evolved. Storage virtualization offers the ability to isolate a host from the effects of changes in the physical placement of a storage device. The result is a substantial reduction in impact on an end user and the need for technical support.

An exemplary SAN includes a virtualization switch, a plurality of hosts, a wireline connection to a storage device (e.g., Fiber Channel™, parallel SCSI, or iSCSI), and a plurality of storage devices. Hosts are connected to a virtualization switch through a network. The connections formed between the hosts and a virtualization switch can transmit messages according to any protocol including, but not limited to, iSCSI over Gigabit™ Ethernet and Infiniband™. Storage devices may be connected to a virtualization switch through a Fiber Channel (FC) connection. In some configurations, storage devices are connected to a virtualization switch through FC switches. These storage devices may include, but are not limited to, tape drives, optical drives, disks, and Redundant Array of Independent Disks (RAID).

Any of the previously mentioned storage devices are addressable using a logical unit number (LUN). LUNs are used to identify a virtual volume that is present in a storage subsystem or network device. Virtual volume is treated as though it is a physical disk. More specifically, a virtual volume can be created, expanded, deleted, moved, and selectively presented—all independently of the storage subsystems on which it resides. A virtual volume encompasses stripe, mirror, concatenate, snapshot, sub-disk, and simple volume or any combination thereof. Each virtual volume consists of one or more component virtual volumes and optionally, one or more logical units (LUs), each identified by a LUN. LUNs are specified in a SCSI command and are configured by a user (e.g., a system administrator). Each LUN, and hence each virtual volume, is comprised of one or more contiguous partitions of storage space on a storage device. That is, a virtual volume may occupy a whole storage device, a part of a single storage device, or parts of multiple storage devices. Storage devices are also referred to as targets. In a client-server model, a target corresponds to a server, while a host corresponds to the client. A host creates and sends commands to a target that is specified by a LUN.

A virtualization switch has to be configured for the management of storage devices and hosts, as well as for creating virtual volumes and establishing virtual paths. To create a single virtual volume, a user selects a storage device or devices, defines the type of virtual volume, sets LUNs and targets, and exposes virtual volume on a virtualization switch. In addition, a user sets a plurality of configuration parameters for the management of a virtualization switch. Configuration parameters include Internet protocol (IP) addresses, portal and access permissions, and other administration information.

As the complexity and size of storage systems and networks increase, issues associated with configuring virtualization switches and managing configurations multiply. These issues require further consideration in storage networks that include multiple clusters of virtualization switches. Therefore, it would be advantageous to provide a management tool that would simplify the process of configuring and managing clusters of virtualization switches.

Whatever the precise merits, features, and advantages of the above cited references, none of them achieves or fulfills the purposes of the present invention.

### SUMMARY OF THE INVENTION

A method and a graphical user interface (GUI) for managing and configuring clusters of virtualizations switches of a storage area network (SAN) are disclosed. The present invention allows a user (e.g., a system administrator) to easily create virtual volumes through a virtual management unit (VMU) and configure virtual volumes through a GUI. Virtualization switches are graphically configured by first graphically entering management parameters of a virtualization switch in a cluster. Management parameters include, but are not limited to the following: Internet protocol (IP) address of a virtualization switch, user datagram protocol (UDP) port number, identification (ID) name of a virtualization switch, and administration information. In further detail, the step of graphically creating virtual volumes includes selecting storage devices to be included in a virtual volume, determining the type of virtual volume, exposing virtual volume on a virtualization switch, and configuring virtual volumes. Next, a virtual volume to be exposed on a virtualization switch is graphically configured. Following graphical configuration, volume parameters of a virtual volume are configured. Volume parameters include, but are not limited to the following: virtual volume's identification (ID) name, logical unit numbers (LUNs), and targets. For each new virtualization switch added to a cluster, management parameters of the added virtualization switch are entered. Lastly, volume parameters of a newly added virtualization switch are synchronized with existing virtualization switches.

Furthermore, the disclosed method enables the monitoring of virtualization switch status and is further capable of indicating failures by sending alerts to a user through a data manager that facilitates communication with virtualization switches.

### BRIEF DESCRIPTION OF THE DRAWINGS

FIG. 1 illustrates an exemplary SAN.

FIG. 2 illustrates a detailed view of an exemplary diagram of a SAN.

FIG. 3 is a block diagram illustrating a virtualization switch.

FIG. 4 is a block diagram illustrating a management engine.

FIG. 5 is an exemplary screenshot of a GUI displaying the hierarchy of virtual volumes exposed on a virtualization switch.

FIGS. 6A & 6B are exemplary screenshots of a GUI for creating virtual volumes.

FIG. 7 is a process flow diagram illustrating a method for configuring a cluster of virtualization switches.

FIGS. 8A & 8B are lists of alerts generated by a management engine.

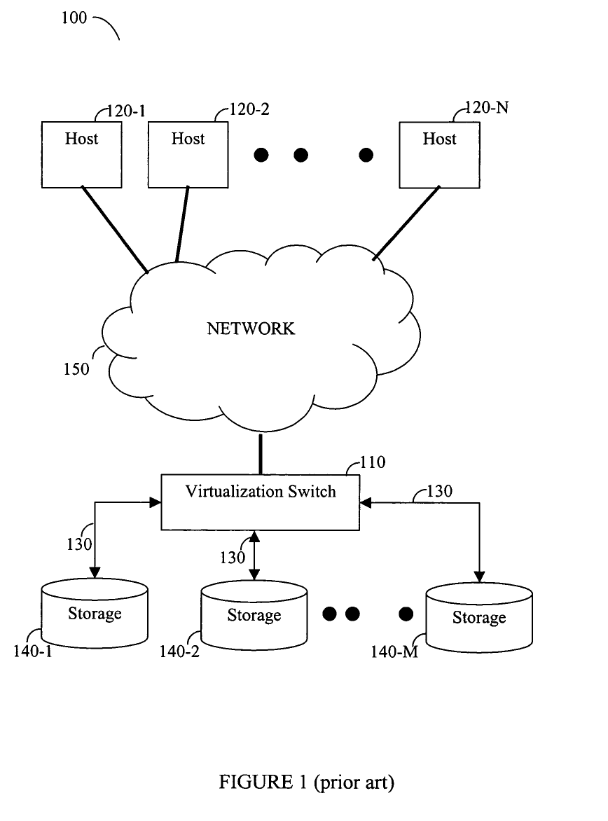

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

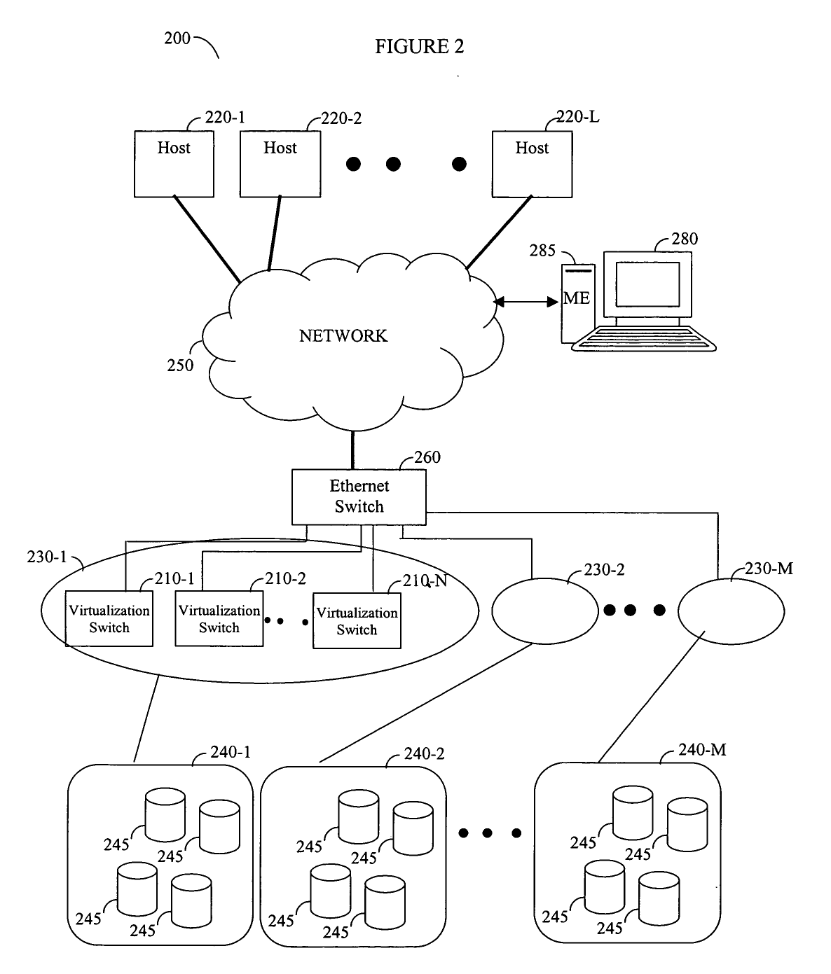

FIG. 2 illustrates an exemplary diagram of a SAN 200. SAN 200 comprises M clusters 230-1 through 230-M, N virtualization switches 210-1 through 210-N, network 250, a plurality of hosts 220-1 through 220-L, and M independent storage pools 240-1 through 240-M. Clusters 230 may be geographically distributed. Host 220 may be connected to network 250 through a local area network (LAN) or a wide area network (WAN). Hosts 220-1-220-L communicate with virtualization switches 210-1-210-N through network 250. Connections formed between hosts 220 and virtualization switches 210 can utilize any protocol including, but not limited to, Gigabit Ethernet carrying packets in accordance with an iSCSI, Infiniband, or other protocol. The connections are routed to cluster 230-1 through an Ethernet switch 260. Virtualization switches 210 in a cluster 230-i are connected to storage pool 240-i. Storage pool 240 includes a plurality of storage devices 245. Storage devices 245 may include, but are not limited to, tape drives, optical drives, disks, and redundant array of independent (or inexpensive) disks (RAID). Additionally, in some configurations storage devices 245 are connected to virtualization switches 210-1 through 210-N through one ore more FC switches. Each virtualization switch 210-1 through 210-N has to be connected to a single storage pool 240. If a virtualization switch is not connected to storage pool 240, an error is generated. SAN 200 further includes a terminal 280 that allows a user to configure and control clusters 230-1 through 230-M. Terminal 280 includes a management engine (ME) 285, display means, and input means, such as a keyboard, a mouse, and a touch screen through which a user performs functions including entering commands and inputting functions. ME 285 executes all tasks related to configuring, managing, and administrating clusters 230-1 through 230-M. ME 285 and its functionalities are described in greater detail in following sections.

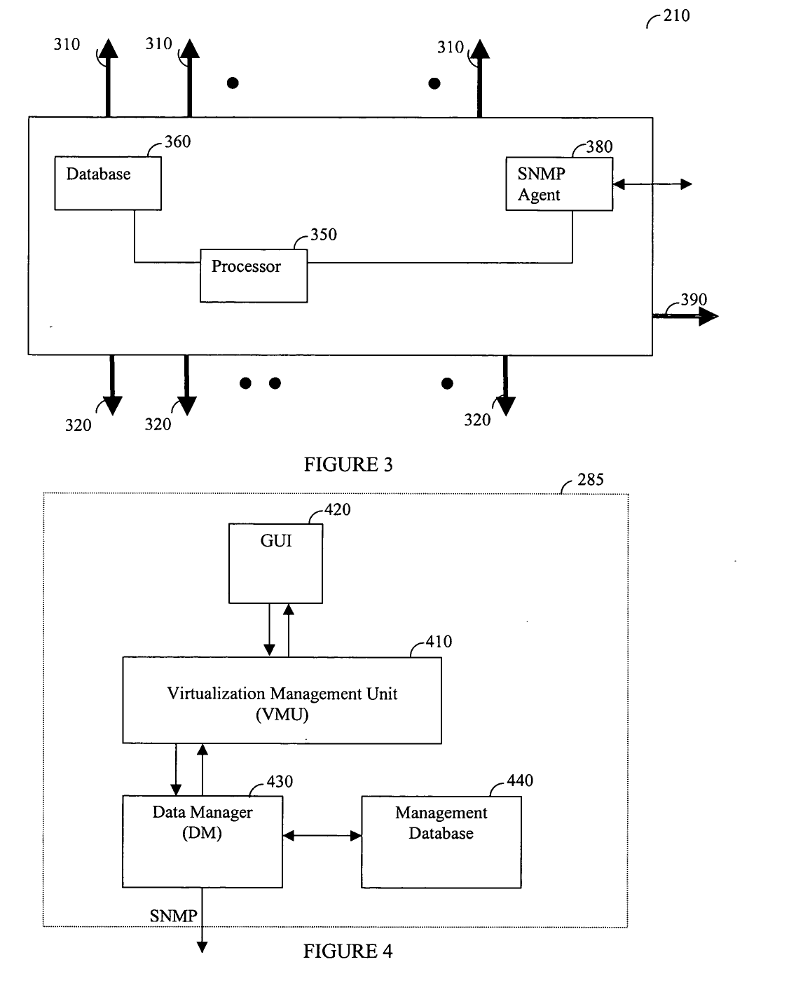

Referring now to FIG. 3, a detailed diagram of virtualization switch 210-1 is shown. Virtualization switch 210-1 includes a plurality of input ports 310, a plurality of output ports 320, a database 360, simple network management protocol (SNMP) agent 380, and aport 390 for communicating with other virtualization switches 210 in cluster 230 as well as with management station ME 285. In addition, virtualization switches 210 may communicate with each other through input ports 310. Messages between virtualization switches 210 are transmitted through network 250, hence virtualization switches 210, connected in the same cluster 230, may be geographically distributed. SNMP agent 380 uses for communicating with ME 285 by means of an SNMP protocol. Input ports 310 may be, but are not limited to, gigabit Ethernet ports, FC ports, and parallel SCSI ports. Output ports 320 may be, but are not limited to, FC ports, iSCSI ports, parallel SCSI ports. Database 360 maintains configurations related to virtualization switches 210 in a cluster. Configurations include a management IP address, a virtualization switch identification (ID) name, a user datagram protocol (UDP) port, logic unit numbers (LUNs), exposed virtual volumes, and other administration information. Database 360 may be flash memory, programmable read only memory (PROM), erasable programmable read only memory (EPROM), electrically erasable programmable read only memory (EEPROM), hard disk, or any other type of non-volatile memory. Virtualization switch 210 further includes processor 350 for executing virtualization operations supported by virtualization switch 210.

In FIG. 4, a block diagram of ME 285 is shown. ME 285 executes all activities related to managing, monitoring, administering, and configuring virtualization switches 210-1 through 210-M. In addition, ME 285 provides for a graphical user interface (GUI) for all configuration operations and status indications. ME 285 comprises a virtual management unit (VMU) 410, a GUI 420, a data manager (DM) 430, and a management database 440. VMU 410 provides an abstraction of a storage network, in this case, a storage pool 240. VMU 410 maintains virtual volumes defined for each virtualization switch 210 in each cluster 230. A virtual volume may be a simple volume, a mirror volume, a concatenate volume, a strip volume, a sub-disk, a snapshot volume, or a collection of virtual volumes. For each exposed virtual volume, VMU 410 holds targets and LUNs as configured by a user. VMU 410 provides GUI 420 with a hierarchy of exposed virtual volumes.

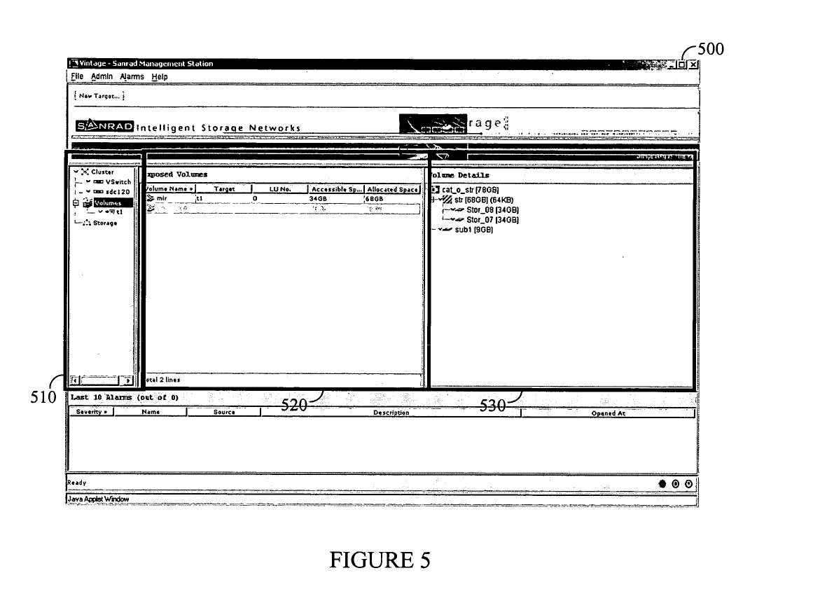

FIG. 5 is an exemplary screenshot 500 displaying the hierarchy of virtual volumes exposed on virtualization switch 210. Screenshot 500 includes three display areas 510, 520, and 530. Display area 510 displays information on clusters 230, virtualization switches 210 in each cluster 230, and storage devices 245. Display area 520 displays a list of exposed virtual volumes. By clicking on a virtual volume, its hierarchy and its logical units are displayed on display area 530. As is shown in display area 530, a virtual volume named “cat_{—}0_str” is a concatenation of a stripe volume named “str” and a sub-disk volume named “sub1”. Stripe volume “str” includes two physical storage disks named “Store_{—}08” and “Store_{—}07”. Each type of virtual volume is presented with an accompanying icon representing that type of virtual volume. Generally, the term “clicking” refers to the action of placing a user interface cursor over a visual element and then pressing an action key on an input device controlling the cursor.

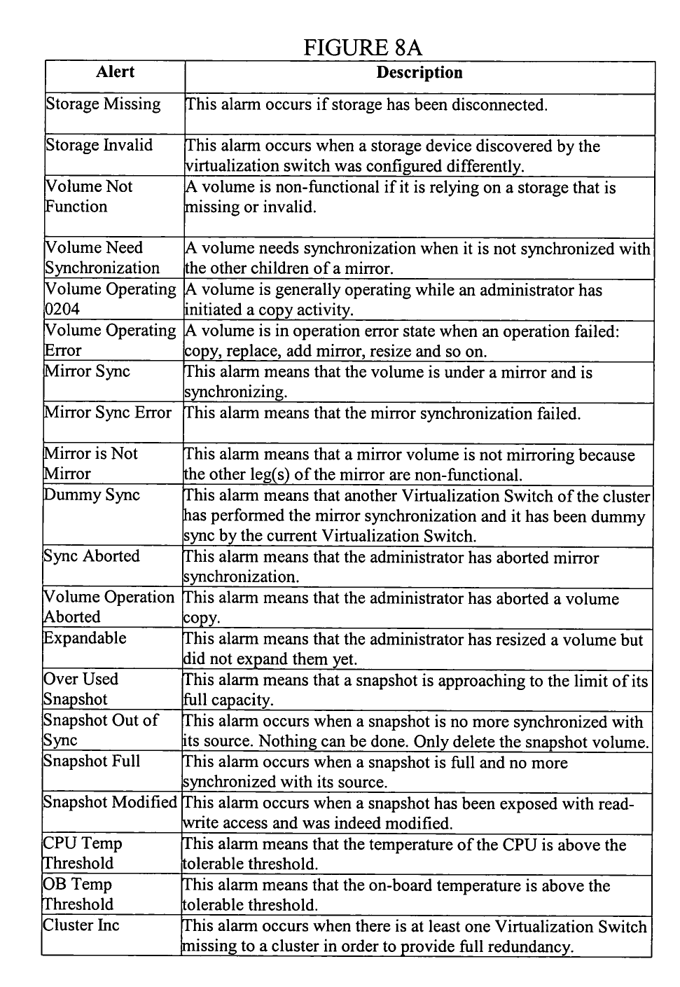

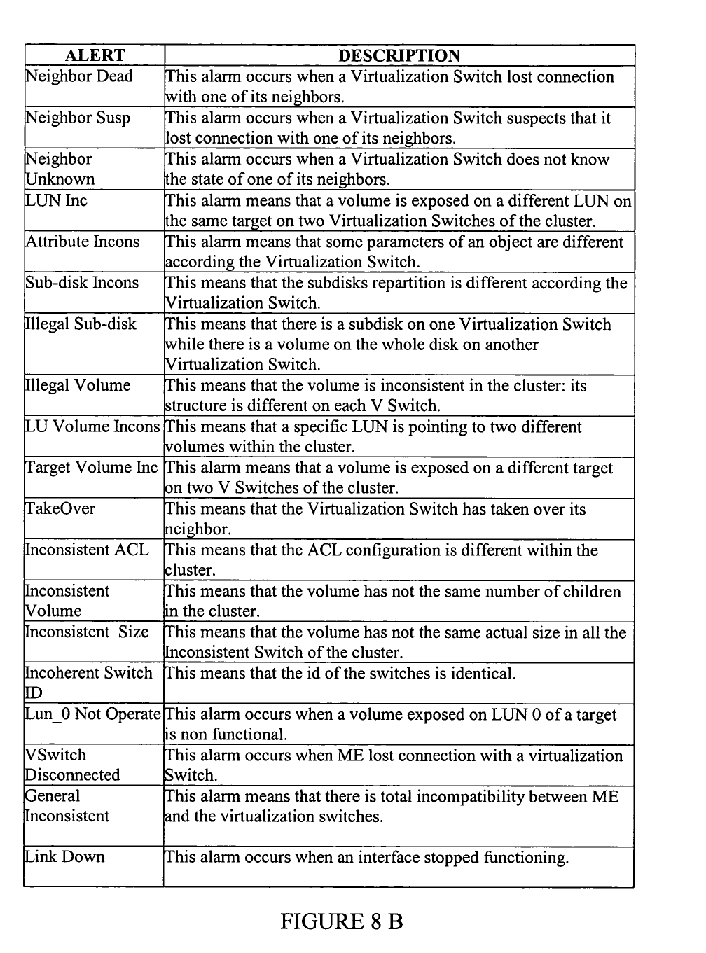

VMU 410 is further capable of generating a plurality of alerts notifying a user of failures occurring during the configuration or operation of virtualization switches 210. Alerts are displayed to a user and may be sent to a user as email messages via an email system. Shown in FIG. 8 is an exemplary list of alerts generated by VMU 410.

DM 430 interfaces with VMU 410 and virtualization switch 210 and also manages the content of management database 440. This includes saving in management database 440 and dynamically updating configuration parameters. Configuration parameters include, but are not limited to, management IP addresses, ID name, a UDP port number, and other administration information. Saving configuration parameters in management database 440 allows virtualization switches 210 to be configured by a user in a single step. Management database 440 may be any non-volatile memory, such as flash memory, PROM, EPROM, EEPROM, hard disk, diskette, compact disk, and the like. DM 430 communicates with virtualization switches 210 through SNMP by exchanging management information base (MIB) messages. ME 285 provides a user with GUI 420 that significantly simplifies the process of creating and configuring virtual volumes.

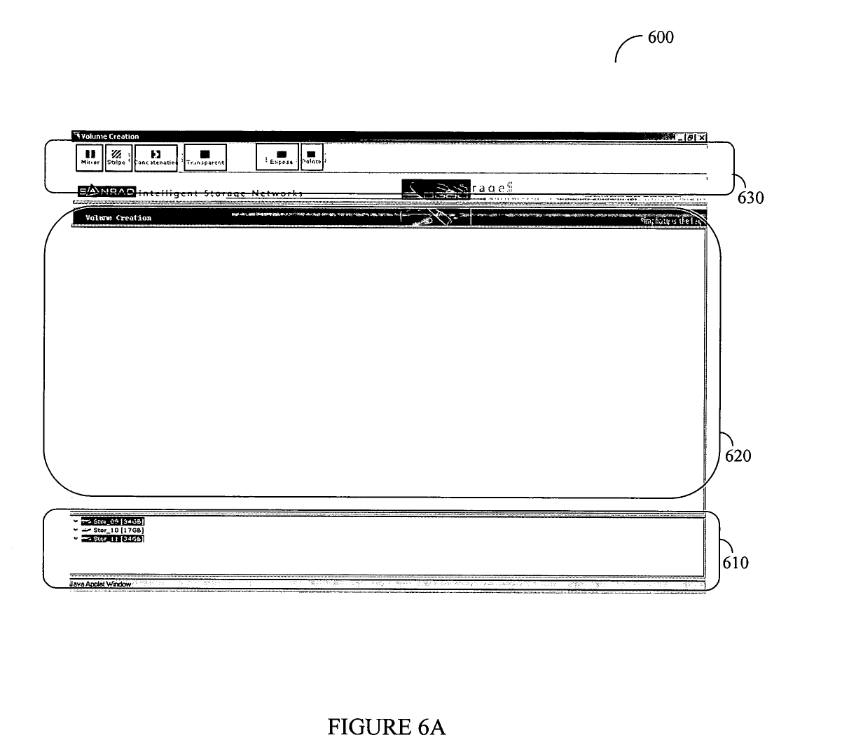

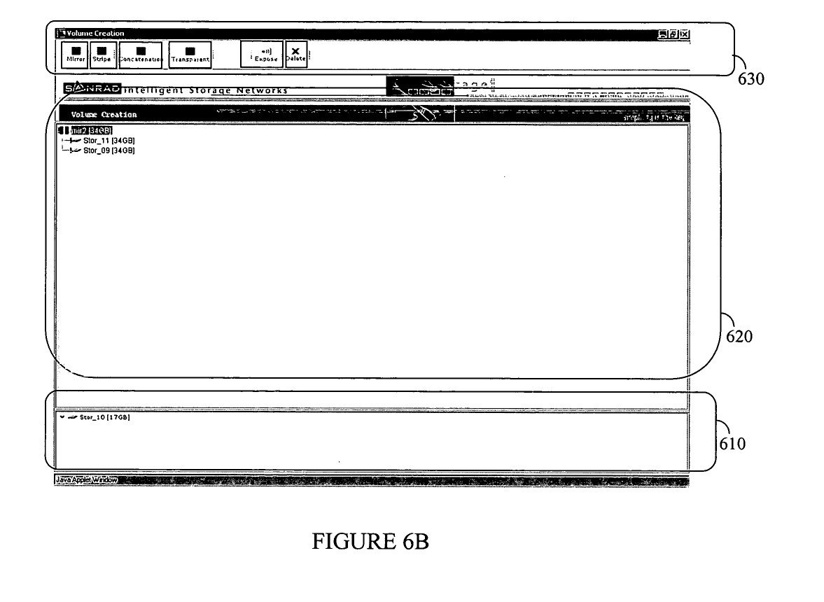

An exemplary screenshot 600 of a GUI for creating virtual volumes is shown in FIG. 6A. Screenshot 600 includes display areas 610 and 620 as well as a toolbar 630. Display area 610 displays a list of physical storage devices (e.g., storage devices 245), display area 620 displays virtual volumes that have been created, and toolbar 630 provides functions for creating and managing virtual volumes. In order to create a mirror virtual volume, a user first selects storage devices to be included in virtual volumes. Selection is made by clicking, e.g., using a mouse on requested storage devices shown in display area 610. In FIG. 6, selected disks are labeled “Stor_{—}9” and “Stor_{—}11”. Second, after selecting storage devices, a user clicks on a mirror button shown in toolbar 630. Finally, a user is prompted to enter a name for a new mirror volume. As shown in FIG. 6B, after providing a name, the new mirror volume and its physical units are hierarchically displayed in display area 620. A user may then choose to expose new virtual volume by clicking on an “expose” button.

To create a mirror volume ME 285, the following steps are executed: VMU 410 translates a request from GUI 420 to a command, e.g., “create mirror on Stor_{—}9 and Stor_{—}11” and transfers this command to DM 430. Since “Stor_{—}9” and “Stor_{—}11” are not virtual volumes, they cannot form a mirror volume. Hence, DM 430 translates a command received from VMU 410 to three commands, the first two commands create simple volumes (i.e., virtual volumes with a simple type) and a third command creates a mirror volume using two simple volumes. Commands generated by DM 430 are:
1. “create simple_{—}1 on Stor_{—}9”
2. “create simple_{—}2 on Stor_{—}11”
3. “create mirror on simple_{—}1 and simple_{—}2”.

These commands are passed to virtualization switch 210, which subsequently creates a mirror volume and returns an acknowledgment to GUI 420. It should be appreciated by a person skilled in the art that the process described above significantly reduces the time required for creating and configuring a new virtual volume. In comparison, to create a mirror volume using a command interface line (CLI), a user must enter at least the three commands shown above.

To allow for proper functionality of failure, ME 285 monitors virtualization switches 210 in cluster 230 and reports their respective status. In case of failure, ME 285 generates an alert indicating the type of failure. As an example, if a cable that connects one of virtualization switches 210 to a storage device is disconnected, then ME 285 generates two alerts—one indicating that a storage device is disconnected and a second indicating that output port 320 carrying this connection is not functional.

It should be noted by a person skilled in the art that components of ME 285 may be hardware components, software components, firmware components, or any combination thereof.

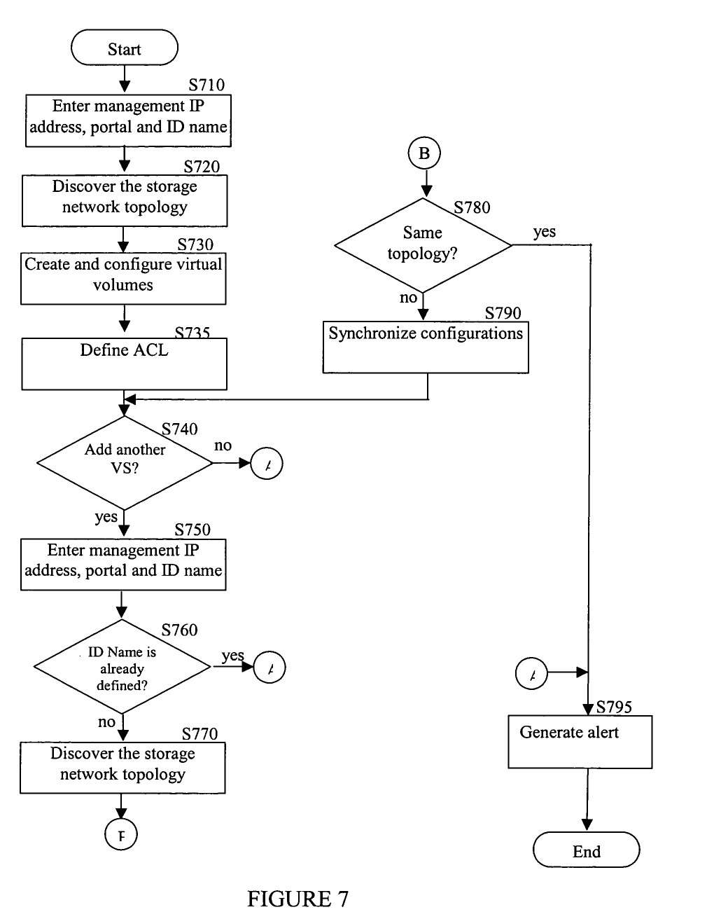

Referring now to FIG. 7, a non-limiting flowchart 700 describing a method for configuring a cluster of virtualization switches in accordance with an embodiment of the present invention is shown. At step S710, a user is prompted to enter a management IP address and a UDP port number of a first virtualization switch 210 (e.g. virtualization switch 210-1) in cluster 230 (e.g. cluster 230-1). Using a management IP address and a UDP port number, ME 285 communicates with a virtualization switch that has been added to a cluster. Optionally, a user may set an ID name for a first virtualization switch. Management IP address, UDP port number, and ID name are saved in management database 440. At step S720, a storage network topology map, i.e., the topology of storage devices connected to a first virtualization switch, is automatically discovered and presented to a user. At step S730, virtual volumes are created and configured by a user. For each created virtual volume, a user defines LUNs and targets. As described above in greater detail, creation and configuration of virtual volume are performed by using a user friendly GUI. The configurations of virtual volumes are saved in database 360. At step S735, the user may define an access control list (ACL). An ACL determines permissions each initiator (e.g., host 120) has to access a specific storage device. An ACL is saved in database 360 and shared among all virtualization switches in the cluster. At step S740, the user may choose to add other clusters or another virtualization switch to a specified cluster. If a user wishes to add another virtualization switch, then at step S750 the user is prompted to enter a new management IP address, UDP port number, and ID name of a new added virtualization switch. At step S760, a check is performed to determine if the name given to the new virtualization switch is already defined. If so, then at step S795 an alert is generated and execution is terminated; otherwise, the management EP address, the UDP port number, and the ID name are saved in management database 440 and execution continues with step S770. At step S770, the topology of a storage network connected to a new virtualization switch is automatically discovered. At step S780, the storage topology map of a new virtualization switch is compared to the storage topology map of a first virtualization switch in a cluster. If topology maps of the two virtualization switches are not identical, i.e., there is at least one storage device connected to only one of the virtualization switches, an alert is generated. Otherwise, at step S790, virtual volume configurations of a first virtualization switch are synchronized with configurations of a newly added virtualization switch. This includes copying configurations stored in database 360 of a first virtualization switch to database 360 of a newly added virtualization switch and applying virtual volume definition of a first virtualization switch to the newly added virtualization switch. In some embodiments, partial synchronization is allowed. Specifically, this means copying only configurations of those storage devices that are connected to a first virtualization switch and to newly added virtualization switch.

Configuration operations described are executed on all virtualization switches 210 of a specific cluster 230. If configurations of virtualization switches 210 are not synchronized, then a user may request through GUI 410 to perform automatic synchronization.

Additionally, the present invention provides for an article of manufacture comprising computer readable program code contained within implementing one or more modules to manage, configure, and monitor virtualization switches in a cluster. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) graphically entering management parameters of a virtualization switch in a cluster, (b) graphically creating a virtual volume to be exposed on a virtualization switch, (c) configuring volume parameters of a virtual volume, (d) entering management parameters of a new virtualization switch, and (e) synchronizing volume parameters of a virtualization switch.

### Conclusion

A system and method has been shown in the above embodiments for the effective implementation of a method and graphical user interface (GUI) for managing and configuring multiple clusters of virtualization switches. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of graphics or object-oriented programming.

1. A management engine for configuring and managing a cluster of virtualization switches, said management engine comprises:
a virtual management unit (VMU) for creating virtual volumes,
a graphical user interface (GUI) for allowing a user to perform at least graphical
configuration operations and further displaying status indications, and
a data manager (DM) for facilitating communication with said virtualization switches.

2. A management engine, as per claim 1, further comprising a management database for maintaining at least management parameters of said virtualization switches.

3. A management engine, as per claim 2, wherein said management parameters comprise at least one of: Internet protocol (EP) address, user datagram protocol (UDP) port number, and identification (ID) name.

4. A management engine, as per claim 1, wherein said virtual volume is at least one of: simple volume, mirror volume, concatenate volume, strip volume, sub-disk, snapshot volume, and collection of virtual volumes.

5. A management engine, as per claim 1, wherein said VMU provides an abstraction layer of a storage network connected to said virtualization switches.

6. A management engine, as per claim 5, wherein said storage network comprises at least one of: optical drive, disk, and redundant array of independent disks (RAID).

7. A management engine, as per claim 1, wherein said cluster of virtualization switches operate in either one or both of: a storage area network (SAN) and a network attached storage (NAS).

8. A management engine, as per claim 1, wherein said virtualization switches are geographically distributed.

9. A management engine, as per claim 1, wherein creating said virtual volume comprises steps of:
a. selecting storage devices to be included in each of said virtual volumes,
b. determining the type of said virtual volume,
c. exposing said virtual volume on said virtualization switch, and
d. configuring volume parameters of said virtual volumes.

10. A management engine, as per claim 9, wherein volume parameters comprise at least: an identification (ID) name of said virtual volume, logical unit numbers (LUNs), and targets.

11. A management engine, as per claim 1, wherein said GUI displays a topology map of said storage network.

12. A management engine, as per claim 1, wherein said GUI displays the hierarchy of said virtual volumes.

13. A management engine, as per claim 12, wherein each of said virtual volumes is presented with an accompanying icon, said icon being representative of at least the type of virtual volume of said virtual volumes.

14. A management engine, as per claim 1, wherein said VMU generates a plurality of alerts.

15. A management engine, as per claim 14, wherein said alerts indicate at least: failures, status of said virtualization switches, and status of said cluster.

16. A management engine, as per claim 1, wherein said DM communicates with said virtualization switches through SNMP by exchanging management information base messages.

17. A management engine, as per claim 2, wherein said DM updates the content of said management database.

18. A management engine, as per claim 1, wherein configuring said cluster of virtualization switches comprises automatically applying volume parameters of a first virtualization switch connected in said cluster to a new virtualization switch added to said cluster.

19. A management engine, as per claim 3, wherein said management parameters are shared among all virtualization switches in said cluster.

20. A graphical user interface (GUI) for graphically configuring a cluster of virtualization switches, said GUI comprises graphical means for creating and configuring virtual volumes and graphical means for displaying at least said virtual volumes and a topology map of a storage network.

21. A GUI, as per claim 20, wherein said virtual volume is at least one of: simple volume, mirror volume, concatenate volume, strip volume, sub-disk, snapshot volume, and a collection of virtual volumes.

22. A GUI, as per claim 20, wherein said storage network comprises at least one of: tape drive, optical drive, disk, and a redundant array of independent disks (RAID).

23. A GUI, as per claim 20, wherein said cluster of virtualization switches operate in either one or both of storage area network (SAN) and network attached storage (NAS).

24. A GUI, as per claim 20, wherein said virtualization switches in said cluster are geographically distributed.

25. A GUI, as per claim 20, wherein said graphical means for creating virtual volume comprises selection means for selecting storage devices to be included in each of said virtual volumes.

26. A GUI, as per claim 25, wherein said graphical means for creating virtual volumes further comprises means for determining the type of each of said virtual volumes and means for exposing each of said virtual volumes.

27. A GUI, as per claim 25, wherein said graphical means for creating virtual volumes is a toolbar.

28. A GUI, as per claim 27, wherein said toolbar includes a plurality of functional buttons each defining a different function for the creation of said virtual volume.

29. A GUI, as per claim 28, wherein said functional buttons are perform at least the following functions: creating a mirror volume, creating a concatenation volume, creating a stripe volume, creating a transparent volume, exposing a virtual volume on said virtualization switch, and deleting a virtual volume.

30. A GUI, as per claim 20, wherein said graphical means for creating virtual volumes comprises at least one of: pop-up means, means to drag the selected physical storage devices, means for marking a portion of a storage device.

31. A GUI, as per claim 20, wherein said virtual volumes are hierarchically displayed.

32. A GUI, as per claim 31, wherein each of said virtual volumes is presented with an accompanying icon, said icon representing the type of said virtual volume.

33. A method for graphically configuring a cluster of virtualization switches, said method comprises the steps of:
a. graphically entering at least management parameters of a first virtualization switch in said cluster,
b. graphically creating at least one virtual volume to be exposed on said first virtualization switch, wherein the creation of said virtual volume is performed using a graphical user interface (GUI),
c. configuring at least volume parameters of said virtual volume,
d. entering at least management parameters of said new virtualization switch for each new switch, and
e. synchronizing said volume parameters of said first virtualization switch with said volume parameters of said new virtualization switch.

34. A method, as per claim 33, wherein prior to creating step, said method further comprises the step of discovering a topology map of a storage network connected to said first virtualization switch.

35. A method, as per claim 34, wherein said method is further operative for generating a plurality of alerts indicating failures occurring during at least the operation of said virtualization switch and the configuration of said virtualization switch.

36. A method, as per claim 33, wherein said management parameters comprise at least: internet protocol (IP) address of said virtualization switch, user datagram protocol (UDP) port number, identification (ID) name of said virtualization switch, administration information.

37. A method, as per claim 33, wherein said virtual volume is at least one of: mirror volume, concatenate volume, stripe volume, simple volume, sub-disk, collection of virtual volumes.

38. A method, as per claim 33, wherein said volume parameters comprise at least: virtual volume's identification (ID) name, logical unit numbers (LUNs), targets.

39. A method, as per claim 33, wherein graphically creating said virtual volume comprises the steps of:
a. selecting one or more storage devices to be included in said virtual volume,
b. determining the type of said virtual volume,
c. exposing said virtual volume on said virtualization switch, and
d. configuring said virtual volumes.

40. A method, as per claim 39, wherein the step of graphically creating said virtual volume is performed using graphical means, said graphical means comprises at least one of: toolbar, pop-up means, means to drag selected physical storage devices, and a means for marking a portion of a storage device.

41. A method, as per claim 33, wherein the step of synchronizing said volume parameters eliminates the need to configure each new virtualization switch installed in said cluster.

42. Computer executable code for configuring a cluster of virtualization switches, said code comprises the steps of:
a. graphically entering at least management parameters of a first virtualization switch in said cluster, the creation of said virtual volume is performed using graphical user interface (GUI),
b. graphically creating at least one virtual volume to be exposed on said first virtualization switch,
c. configuring at least volume parameters of said virtual volume,
d. for each new virtualization switch added to said cluster, entering at least management parameters of said new virtualization switch, and
e. synchronizing said volume parameters of said first virtualization switch with said volume parameters of said new virtualization switch.

43. Computer executable code, as per claim 42, wherein prior to said graphical creation step, said method further comprises the step of discovering topology map of a storage network connected to said first virtualization switch.

44. Computer executable code, as per claim 43, wherein said code is further operative for generating a plurality of alerts indicating failures occurring during at least: operation of said virtualization switch and configuration of said virtualization switch.

45. Computer executable code, as per claim 42, wherein said management parameters comprise at least: internet protocol (IP) address of said virtualization switch, user datagram protocol (UDP) port number, identification (ID) name of said virtualization switch, administration information.

46. Computer executable code, as per claim 42, wherein said virtual volume is at least one of:
mirror volume, concatenate volume, stripe volume, simple volume, sub-disk, collection of virtual volumes.

47. Computer executable code, as per claim 42, wherein said volume parameters comprise at least: virtual volume's identification (ID) name, logical unit numbers (LUNs), and targets.

48. Computer executable code, as per claim 42, wherein graphically creating said virtual volume comprises the steps of:
a. selecting storage devices to be included said virtual volume,
b. determining the type of said virtual volume,
c. exposing said virtual volume on said virtualization switch, and
d. configuring said virtual volumes.

49. Computer executable code, as per claim 48, wherein the step of graphically creating said virtual volume is performed using graphical means, said graphical means comprises at least one of: toolbar, pop-up means, means to drag selected physical storage devices, and means for marking a portion of a storage device.

50. Computer executable code, as per claim 42, wherein the step of synchronizing said volume parameters eliminates the need to configure each new virtualization switch installed in said cluster.

51. An apparatus for graphical configuration and managing a cluster of virtualization switches, said engine is comprised of:
a. a management engine executing configuration and managing operations,
b. means for graphical input,
c. means for graphical display, and
d. means for communicating with said virtualization switches.

52. An apparatus, as per claim 51, wherein said management engine is comprised of:
a. a virtual management unit (VMU) for creating virtual volumes,
b. a graphical user interface (GUI) for allowing a user to perform graphical configuration operations and further displaying status indications, and
c. a data manager (DM) for communication with said virtualization switches.

53. An apparatus, as per claim 51, wherein said graphical input means comprises at least one of: mouse, pointing device, touch screen, and keyboard.
